(19) United States
(12) Patent Application Publication
(10) Pub. No.: US 2004/0215373 A1
(43) Pub. Date: Oct. 28, 2004

(54) System and method for communicating vehicle management information between vehicles using an ad-hoc network

(75) Inventors: Eun-Tae Won, Seoul (KR); Chang-Kyun Lee, Sunwon-shi (KR); Suk-In Jung, Seoul (KR); Kyung-Hee Lee, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/797,555

(22) Filed: Mar. 10, 2004

(30) Foreign Application Priority Data
Apr. 22, 2003 (KR) 2003/25423

(51) Int. Cl. G06F 17/00

(52) U.S. Cl. 701/1

(57) ABSTRACT

A system and method for communicating vehicle management information between vehicles using an ad-hoc network. The system and method forms a routing path based on vehicle management information of individual vehicles, and communicates the vehicle management information between the vehicles along the routing path. A source vehicle collects its own vehicle driving information, and creates vehicle management information of the source vehicle based on the vehicle driving information. The source vehicle sets up a routing condition composed of predetermined vehicle traveling requirements based on the vehicle management information, and transmits a vehicle management information message having the routing condition and the vehicle management information to nearby vehicles. The nearby vehicles search for the routing condition upon receiving the vehicle management information message, and determine whether to route the vehicle management information message according to the routing condition.

This application claims priority to an application entitled “SYSTEM AND METHOD FOR COMMUNICATING VEHICLE MANAGEMENT INFORMATION BETWEEN VEHICLES USING AD-HOC NETWORK”, filed in the Korean Industrial Property Office on Apr. 22, 2003 and assigned Serial No. 2003-25423, the contents of which are hereby incorporated by reference.

### BACKGROUND OF THE INVENTION

1. Field of the Invention

The present invention relates to an apparatus and method for providing an ad-hoc network for communicating vehicle management information between vehicles, and more particularly to an apparatus and method for forming a routing path based on vehicle management information of individual vehicles, and communicating the vehicle management information between the vehicles along the routing path.

2. Description of the Related Art

Following the current trend of rapidly increasing numbers of traffic accidents caused by numerous vehicles throughout the world, increasing the safety of vehicle occupants is a most important matter. A variety of passive vehicle safety devices have been widely used, such as airbags and seat belts, to minimize the level of injuries suffered by vehicle occupants in the case of traffic accidents. Recently, a variety of active vehicle safety devices have been developed, such as ABS (Automatic Breaking System), a system for warning a driver of an insufficient gap between vehicles, and lateral/rear radars. These active vehicle safety devices provide a driver with driving information about nearby vehicles, such that the driver visually or audibly recognizes the driving information of the nearby vehicles.

However, the aforementioned conventional active vehicle safety devices provide a driver with driving information only of nearby vehicles close to the driver's vehicle that have the active vehicle safety device, and do not provide the driver with synthesized information of surrounding driving conditions. Further, the conventional active vehicle safety devices have a disadvantage in that the driver's vehicle is unable to communicate with nearby vehicles in the case of unexpected occurrences, thus possibly resulting in a rear-end collision or other traffic accident. Therefore, there is needed a system for communicating vehicle management information between the driver's vehicle and other nearby vehicles.

Furthermore, the above conventional active vehicle safety devices provide a driver of a vehicle having the active vehicle safety device with driving information only of nearby vehicles, such that the driver cannot recognize unexpected occurrences caused by an inexperienced driver, weather condition information, and road condition information, thereby increasing the danger of traffic accidents or collisions between vehicles. In conclusion, there must be developed a new system for allowing driving information of the driver's vehicle to be shared with the nearby vehicles while warning the driver of a possibility of traffic accidents or collisions, in order to prevent the traffic accidents and collisions between vehicles.

### SUMMARY OF THE INVENTION

Therefore, the present invention has been made in view of the above problems, and it is an object of the present invention to provide a system and method for forming a network between currently driven vehicles, and communicating vehicle management information between the vehicles.

It is another object of the present invention to provide a system and method for forming a temporary network (i.e. an ad-hoc network) based on driving information of currently driven vehicles, and allowing vehicle management information to be shared between the vehicles, thereby preventing or warning of a possibility of traffic accidents or collisions.

It is yet another object of the present invention to provide a system and method for forming a prescribed wireless network between currently driven vehicles in order to enable the vehicles to communicate with each other.

In accordance with one aspect of the present invention, the above and other objects can be accomplished by the provision of a method for forming an ad-hoc network between vehicles to communicate vehicle management information between them, comprising the steps of allowing a source vehicle to collect its own vehicle driving information, and creating vehicle management information of the source vehicle based on the vehicle driving information; allowing the source vehicle to set up a routing condition composed of predetermined vehicle traveling requirements based on the vehicle management information, and transmitting a vehicle management information message having the routing condition and the vehicle management information to nearby vehicles; allowing the nearby vehicles to search for the routing condition upon receiving the vehicle management information message; and determining whether the nearby vehicles route the vehicle management information message according to the routing condition.

In accordance with another aspect of the present invention, there is provided an apparatus for forming an ad-hoc network between a source vehicle and nearby vehicles to communicate vehicle management information between them, comprising: a sensor for collecting vehicle driving information including at least one of vehicle position, direction, and speed information of the source vehicle, a communicator for receiving vehicle management information messages having vehicle management information and a routing condition of the nearby vehicles from the nearby vehicles, inserting a predetermined vehicle traveling requirement into the routing condition, comparing the vehicle traveling requirement with the collected vehicle driving information, and determining whether the vehicle management information message is routed; and a display for informing a driver of the collected vehicle driving information.

In accordance with yet another aspect of the present invention, there is provided an apparatus for forming an ad-hoc network between a source vehicle and nearby vehicles to communicate vehicle management information between them, comprising: a sensor for collecting vehicle driving information including at least one of vehicle position, direction, and speed information of the source vehicle; a communicator for receiving vehicle driving information of nearby vehicles; a controller for creating vehicle management information based on individual vehicle driving information of the source vehicle and the nearby vehicles, for setting up a predetermined routing condition for routing the vehicle management information, for inserting a predetermined vehicle traveling requirement into the routing condition, and for creating a vehicle management information message having the routing condition and the vehicle management information; and a display for informing a driver of the vehicle driving information of the source vehicle, and of the vehicle management information.

In accordance with yet a further aspect of the present invention, there is provided a method for forming an ad-hoc network between a source vehicle and nearby vehicles to communicate vehicle management information between them, comprising the steps of: collecting vehicle driving information including at least one of vehicle position, direction, and speed information of the source vehicle; receiving vehicle management information message including vehicle management information and a routing condition of nearby vehicles from the nearby vehicles, inserting a predetermined vehicle traveling requirement into the routing condition, comparing the vehicle traveling requirement with the collected vehicle driving information, and determining whether the vehicle management information message is routed; and informing a driver of the vehicle driving information of the source vehicle.

In accordance with yet another aspect of the present invention, there is provided a method for forming an ad-hoc network between a source vehicle and nearby vehicles to communicate vehicle management information between them, comprising the steps of: collecting vehicle driving information including at least one of vehicle position, direction, and speed information of the source vehicle; receiving vehicle driving information of the nearby vehicle from the nearby vehicle; creating vehicle management information based on the vehicle driving information of the source vehicle and the nearby vehicles, setting up a routing condition for routing the vehicle management information, inserting a predetermined vehicle traveling requirement into the routing condition, and creating a vehicle management information message having the routing condition and the vehicle management information; and informing a driver of the vehicle driving information and the vehicle management information of the source vehicle.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram of a driving information communication system for use in a vehicle in accordance with a preferred embodiment of the present invention;

FIG. 2 is a block diagram of a communicator of FIG. 1 in accordance with a preferred embodiment of the present invention,

FIG. 3 is a view illustrating a header structure of a vehicle management information message in accordance with a preferred embodiment of the present invention;

FIG. 4 is a view illustrating a header structure of a vehicle management information message when a source vehicle broadcasts its own driving information message to nearby vehicles in accordance with a preferred embodiment of the present invention;

FIG. 5 is a view illustrating a routing path of a vehicle management information message when a source vehicle broadcasts its own driving information message to nearby vehicles in accordance with a preferred embodiment of the present invention;

FIG. 6 is a view illustrating a header structure of a vehicle management information message when a source vehicle broadcasts its own driving information message to nearby vehicles contained in a prescribed area in accordance with another preferred embodiment of the present invention;

FIG. 7 is a view illustrating a routing path of a vehicle management information message when a source vehicle broadcasts its own driving information message to nearby vehicles contained in a prescribed area in accordance with another preferred embodiment of the present invention;

FIGS. 8A and 8B are views illustrating a header structure of a vehicle management information message when a source vehicle transmits its own driving information message to a prescribed vehicle in accordance with yet another preferred embodiment of the present invention;

FIG. 9 is a view illustrating a routing path of a vehicle management information message when a source vehicle transmits its own driving information message to a prescribed vehicle in accordance with yet another preferred embodiment of the present invention;

FIGS. 10A, 10B, 10C, and 10D are views illustrating a header structure of a vehicle management information message when a source vehicle selects more than two routing paths and transmits its own driving information message to a prescribed vehicle using a flooding algorithm in accordance with yet another preferred embodiment of the present invention;

FIG. 11 is a view illustrating a routing path of the vehicle management information message when a source vehicle selects more than two routing paths and transmits its own driving information message to a prescribed vehicle using a flooding algorithm in accordance with yet another preferred embodiment of the present invention;

FIGS. 12A, 12B, 12C, and 12D are views illustrating a header structure of a vehicle management information message when a source vehicle broadcasts its own driving information message to all the vehicles contained in a prescribed surrounding area in accordance with yet another preferred embodiment of the present invention;

FIG. 13 is a view illustrating a routing path of a vehicle management information message when a source vehicle broadcasts its own driving information message to all the vehicles contained in a prescribed surrounding area in accordance with yet another preferred embodiment of the present invention;

FIG. 14 is a conceptual diagram of a method for broadcasting a message (i.e., a traffic accident warning message) to warn a driver of a traffic accident or collision in accordance with a preferred embodiment of the present invention;

FIG. 15 is a conceptual diagram of a method for broadcasting a message (i.e., a traffic accident warning message) to warn a driver of a traffic accident or collision in accordance with another preferred embodiment of the present invention;

FIG. 16 is a conceptual diagram of a method for broadcasting a message to warn nearby vehicles of a source vehicle's entrance into a crossroads in accordance with yet another preferred embodiment of the present invention;

FIG. 17 is a conceptual diagram of a method for broadcasting a warning message to inform vehicles located on a main road of the entrance of a source vehicle to a main road from an arterial road in accordance with yet another preferred embodiment of the present invention;

FIG. 18 is a conceptual diagram of a method for transmitting a message to warn of an impending traffic accident or collision to a certain vehicle in accordance with yet another preferred embodiment of the present invention; and

FIG. 19 is a conceptual diagram of a method for broadcasting a weather condition message to nearby vehicles in accordance with yet another preferred embodiment of the present invention.

### DETAILED DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings. In the following description, a detailed description of known functions and configurations incorporated herein will be omitted when it may make the subject matter of the present invention rather unclear.

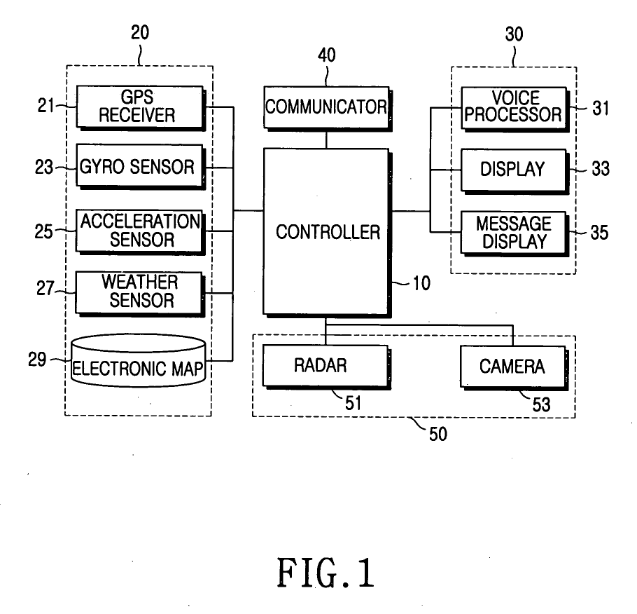

FIG. 1 is a block diagram of a driving information communication system for use in a vehicle in accordance with a preferred embodiment of the present invention. Referring to FIG. 1, the driving information communication system includes a controller 10, a sensor unit 20, a display unit 30, a communicator 40, and an optional unit 50.

The sensor unit 20 includes a GPS (Global Positioning System) receiver 21, a gyro sensor 23, an acceleration sensor 25, a weather sensor 27, and an electronic map 29. The sensor unit 20 collects vehicle driving information and transmits it to the controller 10. In more detail, the GPS receiver 21 collects a source vehicle's position information, and the gyro sensor 23 detects the source vehicle's rotation angle. The acceleration sensor 25 detects the source vehicle's acceleration information. The weather sensor 27 detects weather condition information such as clouds, fog, rain, snow, and drizzle, etc., and provides the controller 10 with the detected weather condition information. The electronic map 29 manages road information such as a degree of curvature of a road, traffic lane information, and road width information, surrounding road information, and nearby area information, etc.

The optional unit 50 includes additional devices such as a radar 51 and a camera 53 additionally mounted to a vehicle. The optional unit 50 may be adapted to enhance accuracy of vehicle driving information collected by the sensor unit 20. For the convenience of description and better understanding of the present invention, the sensor unit 20 and the optional unit 50 will hereinafter be called the sensor unit 20. The sensor unit 20 can recognize the occurrence of a traffic accident involving a driver's vehicle. If airbags are suddenly deployed or the acceleration sensor 25 detects an abrupt deceleration, the sensor unit 20 may determine that a traffic accident has occurred. The detailed description of this traffic accident determination technology will herein be omitted because it is well-known to those skilled in the art.

The controller 10 receives a variety of information from the sensor unit 20. In more detail, the controller 10 receives vehicle position information from the GPS receiver 21, receives vehicle rotation angle information from the gyro sensor 23, receives vehicle acceleration information from the acceleration sensor 25, and receives weather condition information such as fog information from the weather sensor 27. The controller 10 compares vehicle driving information received from the sensor unit 20 and the optional unit 50 with nearby vehicles' driving information received from the communicator 40, and generates vehicle safety information such as a collision warning message and a frontal accident indication message. If any vehicle safety information, such as an abrupt deceleration and a blind corner, is generated upon receiving information controlled by the electronic map 29 and a vehicle traveling speed, the controller 10 generates vehicle safety information indicating such change of vehicle safety information. For example, the controller 10 recognizes a degree of curvature of a road and a current traffic lane width upon receiving road information from the electronic map 29, and thus calculates an appropriate vehicle driving speed. Upon receiving the above vehicle safety information and vehicle driving information, the controller 10 generates vehicle management information to be transmitted to nearby vehicles. The aforementioned vehicle management information may include the above vehicle safety information and vehicle driving information, or may include either one of them.

The term ‘vehicle management information’, as used herein, includes not only vehicle safety information or vehicle driving information, but also any one of messages needed for information communication between vehicles in a broad sense. For example, provided that a plurality of vehicles travel in a group, the vehicle management information may be a prescribed message needed for information communication between these vehicles.

The controller 10 sets up a routing condition for routing the vehicle management information. In more detail, the controller 10 receives various vehicle driving information such as vehicle position, speed, and traveling direction from the sensor unit 20 while receiving the vehicle management information, and sets up a routing condition suitable for routing the vehicle management information based on driving information of a destination vehicle (i.e., a target vehicle). The routing condition may include a variety of vehicle traveling conditions (also called vehicle traveling requirements) such as a vehicle position, speed, and direction of travel. Therefore, only a few vehicles satisfying the above traveling requirements can route the vehicle management information.

The controller 10 creates a vehicle management information message based on the above routing condition (i.e., a travel plan) and the vehicle management information, and transmits the vehicle management information message to nearby vehicles. The vehicle management information message includes a header and a main body, the routing condition is loaded on the header, and the vehicle management information is loaded on the main body.

The communicator 40 is adapted to form a temporary wireless network (e.g., an ad-hoc network) between vehicles. In more detail, the communicator 40 can form such a temporary wireless network using any of a variety of wireless communication methods, for example, a WLAN (Wireless Local Area Network) scheme, a CDMA (Code Division Multiple Access) scheme, a GSM (Global System for Mobile communication) scheme, a Bluetooth scheme, and an OFDM scheme. In this case, it is assumed that the temporary wireless network applied to the present invention is an ad-hoc network, but any one of the network schemes capable of forming such an ad-hoc network between vehicles can be used for this present invention.

The communicator 40 receives vehicle management information messages from nearby vehicles, and detects a routing condition and a message reception condition from header information of the received vehicle management information message. The communicator 40 determines whether the routing condition is compatible with vehicle driving information created by the controller 10, and determines whether the vehicle management information message is routed according to the compatibility determination result. The communicator 40 determines whether the vehicle driving information is compatible with the message reception condition. If they are compatible with each other, the communicator 40 transmits vehicle management information contained in a main body of the vehicle management information message to the controller 10.

The communicator 40 can be connected to common backbone networks over a roadside fixed device or a wireless base station. The fixed device may be a repeater such as a beacon mounted to a roadside area. The repeater may be connected to, for example, a traffic information service center, either by wire or wirelessly. The repeater broadcasts traffic information received from a traffic information center to nearby vehicles, or receives driving information of the nearby vehicles and broadcasts the driving information to vehicles other than the nearby vehicles.

The display unit 30 is adapted to inform a driver of his or her vehicle's driving information created by the controller 10 or driving information received from the nearby vehicles. The display unit 30 may include a voice processor 31, a display 33, and a message display 35. The voice processor 31 audibly informs a driver of his or her vehicle's traveling information created by the controller 10 or received from the nearby vehicles. The display 33 is adapted to indicate vehicle driving information received from the sensor unit 20. The message display 35 is adapted to indicate a variety of vehicle safety information, for example, a traffic collision warning message and a frontal accident indication message, created by the controller 10 or received from the nearby vehicles. Although the display 33 and the message display 35 are separated from each other in the present invention, it should be noted that they can be integrated as one body.

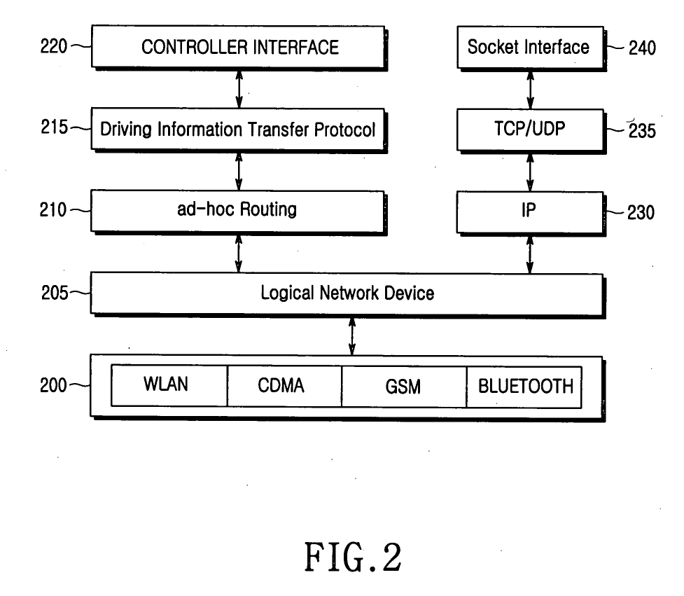

FIG. 2 is a block diagram of the communicator 40 of FIG. 1 in accordance with a preferred embodiment of the present invention. The communicator 40 will hereinafter be described in detail with reference to FIG. 2.

The communicator 40 connects the driving information communication system to an external or internal wireless communication device. The communicator 40 may form an ad-hoc network between vehicles through this communication device, or may communicate with a backbone network through the same. The communicator 40 is connected to a variety of wireless communication units 200 contained in a physical layer, for example, internal or external WLAN, CDMA, GSM, Bluetooth, and OFDM devices. The communicator 40 forms the ad-hoc network using the aforementioned devices. A logical network device 205 is adapted to recognize the above wireless communication units 200 as a logical device. An ad-hoc routing stack 210 configures an ad-hoc network irrespective of the type of wireless communication units 200. The ad-hoc routing stack 210 decodes header information contained in the received vehicle management information message, or encodes header information of a vehicle management information message to be transmitted. A DITP (Driving Information Transfer Protocol) layer 215 formats the vehicle management information message communicated at the driving information communication system, and facilitates coding or decoding operations of the vehicle management information message. The DITP layer 215 encodes a message received from the controller 10 in the form of a DITP, decodes a received message, and transmits the resultant message to the controller 10. A controller interface 220 provides the interface between the DITP layer 215 and the controller 10.

On the other hand, the communicator 40 includes a network device through which the communicator 40 is connected to a backbone network using either a wireless base station such as a WLAN AP(Access Point), a CDMA base station, and a GSM base station, etc., or a fixed device. In order to connect the communicator 40 with the backbone network, the communicator 40 includes an IP (Internet Protocol) 230, a TCP (Transfer Control Protocol) or a UDP (User Datagram Protocol), and a socket interface 240. The IP 230 is a protocol corresponding to a third layer (i.e., a network layer) based on an OSI (Open System Interconnect) model, and is partially used as a TCP/IP. The IP 230 makes it possible to transmit packets between more than two networks (i.e., at least two different networks) according to a prescribed transfer control protocol. The TCP/UDP 235 is a protocol corresponding to a fourth layer (i.e., a transfer layer) based on the OSI model, and arranges received packets in the order of arrival times. The socket interface 240 is a programmer interface of the TCP/IP protocol, and provides the interface between the controller 10 and the TCP/IP protocol.

If there is a need for the driving information communication system to be connected with a backbone network such as an Internet, the driving information communication system is connected to a backbone network over the above network devices contained in the communicator 40. For example, if the electronic map 29 needs to be updated, the driving information communication system is connected to the Internet over the communicator 40 to download a new electronic map from a prescribed server connected to the Internet.

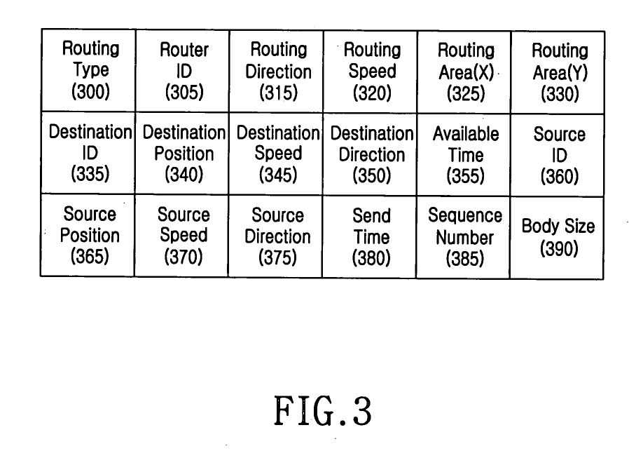

FIG. 3 is a view illustrating a header structure of a vehicle management information message in accordance with a preferred embodiment of the present invention.

Referring to FIG. 3, the controller 10 sets up a routing condition for routing the vehicle management information based on vehicle driving information of a source vehicle and vehicle driving information of nearby vehicles. The vehicle management information includes a position, speed, direction, acceleration, and turning direction or extent of the vehicle. A header structure of the vehicle management information message having the routing condition will hereinafter be described with reference to FIG. 3.

The header includes fields indicating routing vehicle information, fields indicating destination vehicle information, and fields indicating source vehicle information. Fields from a routing type field 300 to a routing area field 330 (300, 305, 315, 320, 325, 330) are adapted to indicate a routing condition (also called a router condition). Fields from a destination ID 335 to a destination direction field 350 (335, 349, 345, 350) are adapted to indicate conditions of a target vehicle (i.e., a destination vehicle) capable of receiving a vehicle management information message. In this case, the conditions of the destination vehicle are defined as reception conditions. If needed, the reception conditions along with the routing vehicle fields may be adapted to indicate a broadcasting area of the vehicle management information message. Fields associated with a source vehicle range from an available time field 355 to a sequence number field 385 (355, 360, 365, 370, 375, 380, 385, 390).

The routing type field 300 indicates a routing method of a message. Although the present invention exemplarily describes a forward routing method, a flooding routing method, a broadcasting routing method, and a combined routing method composed from any of the forward, flooding, and broadcasting routing methods, those skilled in the art will appreciate that routing methods other than the above routing methods are also applicable to the present invention. The forward routing method is a routing method for retransmitting a received message to either the next switching point or the last destination. The flooding routing method is a routing method for transmitting only one message received at a predetermined vehicle to all the vehicles connected to a routing vehicle. The broadcasting routing method is a routing method for transmitting a received message to all nearby vehicles.

In the case where a prescribed routing vehicle for routing a vehicle management information message is determined as in the forward or flooding routing method, the router ID field 305 is adapted to indicate the prescribed routing vehicle ID. However, in the case where such a prescribed routing vehicle is determined as in the broadcasting routing method, the field 305 is indicated as a prescribed symbol or number “0” or “x” or reference characters.

The routing direction field 315 is adapted to route the vehicle management information message, and is a field for setting up a vehicle traveling direction as a routing condition of the vehicle management information message. The running directions of the routing vehicle may be determined as, for example, east(E), west(W), south(S) or north(N). Such a running direction of the routing vehicle may be further subdivided if needed, or may be indicated as an angle instead of such directions. However, provided that a direction of the routing vehicle is not prescribed, the routing direction field 315 usually remains null. The routing speed field 320 enables only a prescribed vehicle, of which a running speed is higher or lower than a predetermined speed, to route the vehicle management information message. A vehicle traveling speed higher than the predetermined speed is displayed in the form of a positive(+) value. A vehicle traveling speed lower than the predetermined speed is displayed in the form of a negative(−) value. The routing area(X) field 325 and the routing area (Y) field 330 are adapted to set up a message broadcasting area when they perform the broadcasting routing along with a destination position field 340. In more detail, the destination position field 340 is adapted to set up a broadcasting area (i.e., a routing area or a destination area) of a vehicle management information message. More than two bits of the routing area(X) field 325 are adapted to identify a front area and a rear area based on the destination vehicle position field 340. At least two bits of the routing area(Y) field 330 are adapted to identify a right area and a left area based on the destination vehicle position field 340. The routing areas vary with, for example, a type of a message to be transmitted, a road condition, and a current driving environment. In more detail, the routing areas can be reduced or increased according to a road width obtained from the electronic map 29 and a vehicle traveling speed. A representative example where two bits of each routing area field are adapted for identification is shown in the following table 1.

TABLE 1

| | 00 | 01 | 10 | 11 |
|---|---|---|---|---|
| Routing area(X) | — | Rear area | Front area | Rear and front |
| | | | | areas |
| Routing area(Y) | — | Left area | Right area | Right and left |
| | | | | areas |

With reference to the above Table 1, a routing direction field 315, a routing speed field 320, a routing area(X) field 325, and a routing area(Y) field 330 are adapted to determine a routing condition to allow only a few vehicles satisfying a prescribed traveling requirement to serve as routing vehicles. In this case, it should be noted that the prescribed traveling requirement contained in the routing condition may further include a vehicle's acceleration or right and left variation rates, i.e., rotation rates.

The destination ID field 335 is a field for indicating an ID of a destination vehicle receiving a vehicle management information message. In the case of broadcasting a message without determining a specific destination vehicle, the destination ID field 335 is displayed in the form of a predetermined character “0” or “*”. In the case where a specific destination vehicle is determined as in the forward or flooding routing, the destination ID field 335 is used. In this case, a destination position field 340, a destination speed field 345, and a destination direction field 350 are associated with the routing condition fields, and allow a routing vehicle prescribed in the routing condition field to select the next routing vehicle. The present invention is characterized in that it does not set up a routing path before sending a message, but sets up the routing path in real time according to traveling information of nearby vehicles. The reason why the routing path is set up in real time is to prevent a predetermined routing path from being separated from an optimum routing path due to a rapid vehicle speed when the routing path is set up before sending a message.

On the other hand, if a vehicle management information message is broadcast to many unspecified vehicles, the destination position field 340 is displayed in the form of a predetermined character, and is adapted to indicate a message broadcasting area. In more detail, the destination position field 340 indicates a reference coordinate of a broadcasting area prescribed in the routing area(X) field 325 and the routing area(Y) field 330. The destination speed field 345 and the destination direction field 350 indicate a vehicle traveling requirement used for receiving the broadcast message in a similar way as in the routing speed field 320 and the routing direction field 315. For example, if the destination speed field 345 is set to a predetermined value “+60”, only vehicles having traveling speeds of more than 60 km/h receive the message. If the destination speed field 345 is set to a predetermined value “−60”, only vehicles having traveling speeds of less than 60 km/h receive the message.

The available time field 355 is adapted to indicate an availability period of a vehicle management information message received from a source vehicle. The source vehicle prevents the message from being indefinitely and repeatedly routed using the available time field 355. The source ID field 360 is a unique ID of a source vehicle. A source position field 365, a source speed field 370, and a source direction field 375 are adapted to allow a source vehicle to indicate its own position, speed, and direction information at a predetermined time at which the vehicle management information message is received by the source vehicle. Information associated with the source vehicle may be used when the source vehicle receiving the vehicle management information message sets up a return path.

The send time field 380 indicates a predetermined time at which the source vehicle sends the vehicle management information message. The sequence number field 385 indicates a sequence number of a message broadcast from the source vehicle. The sequence number field 385 is adapted to determine whether a vehicle receiving a message along with the source ID field 365 repeatedly receives the same message. Finally, a body size field 390 indicates the size of driving information transmitted along with the header.

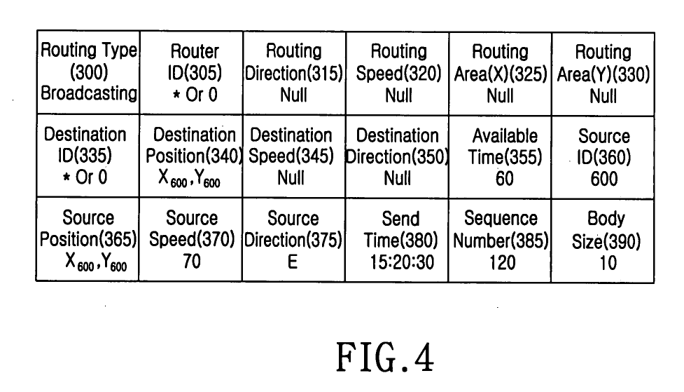

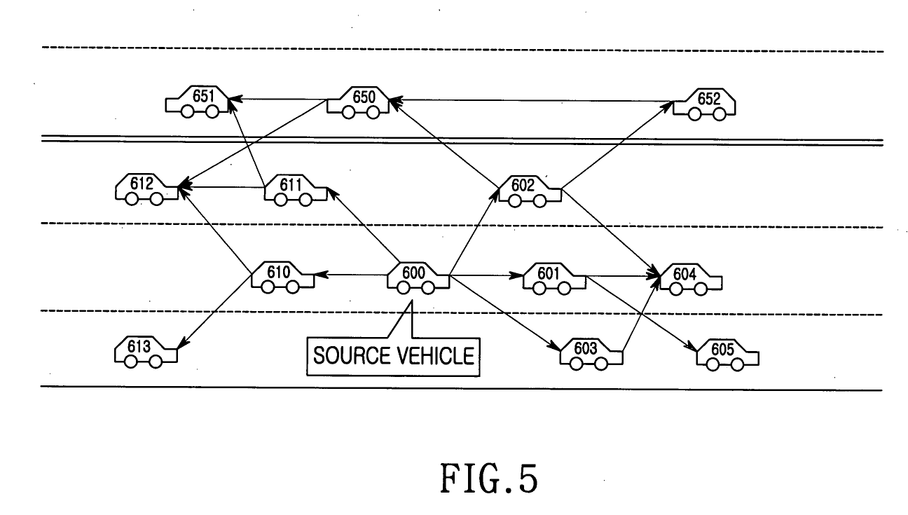

A variety of methods for routing the vehicle management information message will hereinafter be described in more detail with reference to FIG. 3. FIG. 4 is a view illustrating a header structure of the vehicle management information message when a prescribed vehicle proceeding in a traffic lane broadcasts its own driving information message to nearby vehicles. FIG. 5 is a view illustrating a routing path of the vehicle management information message when the prescribed vehicle proceeding in a traffic lane broadcasts its own driving information message to nearby vehicles.

It should be noted that a vehicle 600 is a source vehicle and broadcasts its own driving information message to nearby vehicles. A header of the message is set up as shown in FIG. 4. A routing type field 300 is set to a broadcasting routing method. Because the routing type field 300 does not indicate a specified routing vehicle, a router ID field 305 is set to a predetermined character “0” or “*”. A routing direction field 315, a routing speed field 320, a routing area(X) field 325, and a routing area(Y) field 330 remain null. All nearby vehicles receiving the driving information message of the source vehicle 600 route the driving information message regardless of their positions, speeds, and directions.

A destination ID field 335 is set to a predetermined character “0” or “*”, and indicates that all vehicles can receive the message. A destination position field 340 is set to the same value as in a source position field 365, and indicates that the message is broadcast to nearby vehicles based on the source vehicle 600. In this case, a destination speed field 345 and a destination direction field 350 remain null, and all vehicles receive a message broadcast from the source vehicle 600 irrespective of their speeds and directions. On the other hand, an available time field 355 is set to a predetermined time of, for example, 60 seconds. The message is discarded by a vehicle receiving the message after the lapse of 60 seconds from a predetermined time of 15:20:30 o'clock prescribed in a source time field 380.

The source ID field 360 indicates the identity of the vehicle 600. A source position field 365, a source speed field 370, and a source direction field 375 indicate that the source vehicle 600 is located at a predetermined coordinate (X600, Y600) and runs to the east at a predetermined speed 70 km/h, when the source vehicle 600 broadcasts a vehicle management information message. A sequence number field 385 indicates that the driving information message received from the vehicle 600 has a predetermined sequence number 120. A body size field 390 indicates that vehicle management information is received with the header.

Referring to FIG. 5, the vehicle management information message broadcast from the source vehicle 600 is received at individual communicators 40 of nearby vehicles 601, 602,603, 610 and 611. Individual communicators 40 of the nearby vehicles search for a header of a received message, and allow respective vehicles to recognize that they serve as routing vehicles or destination vehicles. Each communicator 40 transmits a main body of the received message to the controller 10, and re-routes the received message to the nearby vehicles 604, 605, 612, 613, 650, 651 and 652 according to a routing method prescribed in a header of the received message.

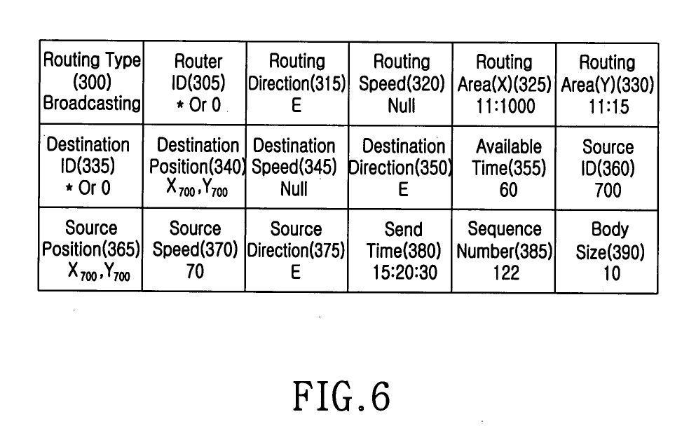

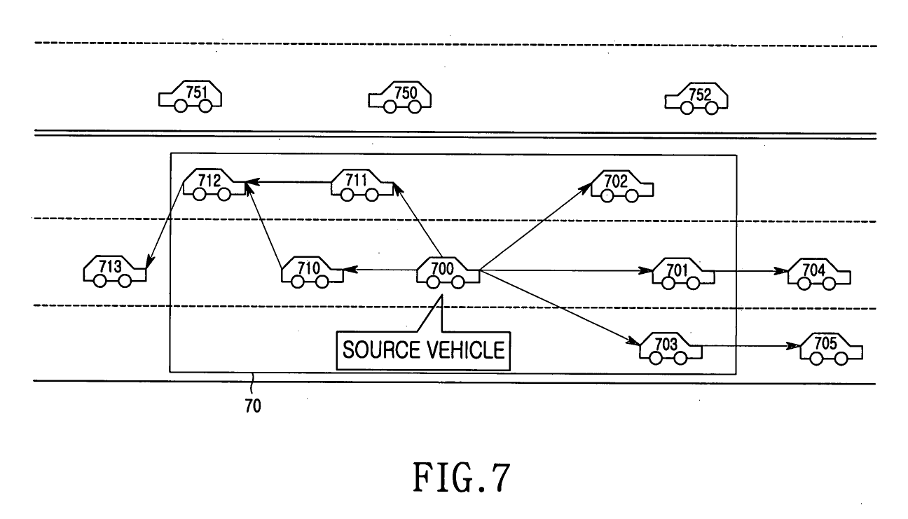

FIGS. 6 and 7 illustrate a method for broadcasting a vehicle management information message to nearby vehicles running in a prescribed area based on a source vehicle in accordance with another preferred embodiment of the present invention. FIG. 6 is a header structure of the vehicle management information message, and FIG. 7 is a routing path through which the vehicle management information message is transmitted.

In FIG. 6, the header is set up to allow only vehicles satisfying a predetermined vehicle traveling requirement to route or receive a driving information message of a source vehicle 700. A routing type field 300 is set to a broadcasting routing method. A router ID field 305 is set to a predetermined character “0” or “*” because a specified routing vehicle is not determined. A routing direction field 315 is set to a prescribed value as a vehicle traveling requirement for routing the vehicle management information message of the source vehicle 700. In more detail, only vehicles running to the east, as in the source vehicle 700, can route the message. A routing speed field 320 remains null, and is not contained in the routing conditions. A routing area(X) field 325 is set to a predetermined value “11:1000”, and indicates vehicles contained in the range of 1 km in front and rear directions of a coordinate prescribed in the destination position field 340. The routing area(Y) field 330 is set to a predetermined value “11:15”, and indicates that the message is routed in the range of 15 m right and left directions of a coordinate prescribed in the destination position field 340. In more detail, it is noted that the vehicle management information message broadcast from the source vehicle 700 according to information prescribed in the header is routed by vehicles running to the east within a prescribed area 70 covering a front and rear distance 1 km from a coordinate prescribed in the destination position field 340 and a right and left distance 15 m from the same coordinate.

In this case, the destination ID field 335 is set to a predetermined character “0” or “*” and indicates a specific destination vehicle is not prescribed. The destination position field 340 indicates a reference position at which the message is broadcast as described above. In this case, the destination direction field 350 is set to the east whereas the destination speed field 345 remains null. Information of the destination direction field 350 is received at vehicles traveling to the east, irrespective of speed information of the vehicles. On the other hand, an available time field 355 is set to a predetermined time of 60 seconds. The message is discarded by a vehicle receiving the message after the lapse of 60 seconds from a predetermined time of 15:20:30 o'clock prescribed in a source time field 380.

The source ID field 360 indicates the vehicle 700. A source position field 365, a source speed field 370, and a source direction field 375 indicate that the source vehicle 700 is located at a predetermined coordinate (X700, Y700) and travels to the east at a predetermined speed 70 km/h, when the source vehicle 700 broadcasts a vehicle management information message. A sequence number field 385 indicates that the vehicle management information message transmitted from the vehicle 700 has a predetermined sequence number 122. A body size field 390 indicates that vehicle management information of 10 bytes is received after the lapse of a predetermined time covered by the header.

Referring to FIG. 7, the vehicle management information message broadcast from the source vehicle 700 is received at individual communicators 40 of nearby vehicles 701, 702, 703, 710 and 711. Individual communicators 40 of the nearby vehicles search for a header of a received message, and allow respective vehicles to recognize that they are contained in the range of routing vehicles or destination vehicles. Each communicator 40 transmits vehicle management information contained in a main body of the received message to the controller 10, and re-routes the received message to the nearby vehicles 704, 705, 712, 750, 751 and 752 according to a routing method prescribed in a header of the received message. In this case, although the vehicles 701, 702, 703, 710 and 711 broadcast the driving information message to all nearby vehicles, FIG. 7 depicts only vehicles receiving the message, for the convenience of description and better understanding of the present invention.

A nearby vehicle 712 compares its own traveling information with a vehicle traveling requirement of a destination condition prescribed in a header of a received message. It is recognized that the nearby vehicle 712 is a destination vehicle, and then the nearby vehicle 712 transmits driving information contained in a main body of the message to the controller 10. It is recognized that the nearby vehicle 712 is a routing vehicle based on vehicle traveling requirements for routing conditions prescribed in a header of the received message, and thereby the nearby vehicle 712 routes the message to the nearby vehicle 713. However, the nearby vehicles 704, 705, 751 and 750 recognize that their traveling information is not compatible with a routing condition of the message header and a vehicle traveling requirement functioning as a message reception condition using their communicators 40, and thereby discard the message. A nearby vehicle 713 receiving the message from the nearby vehicle 712 compares its own traveling information with a routing condition and a message reception condition prescribed in a header of the message. Then, it is recognized that the nearby vehicle 713 is not a routing vehicle or a destination vehicle, and thereby the nearby vehicle 713 discards the message.

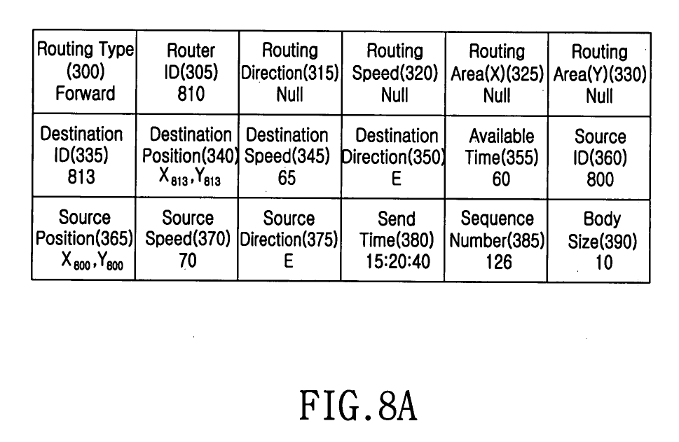

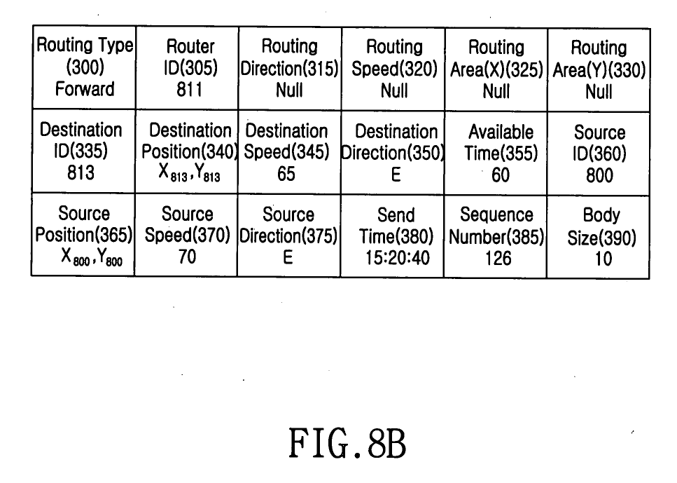

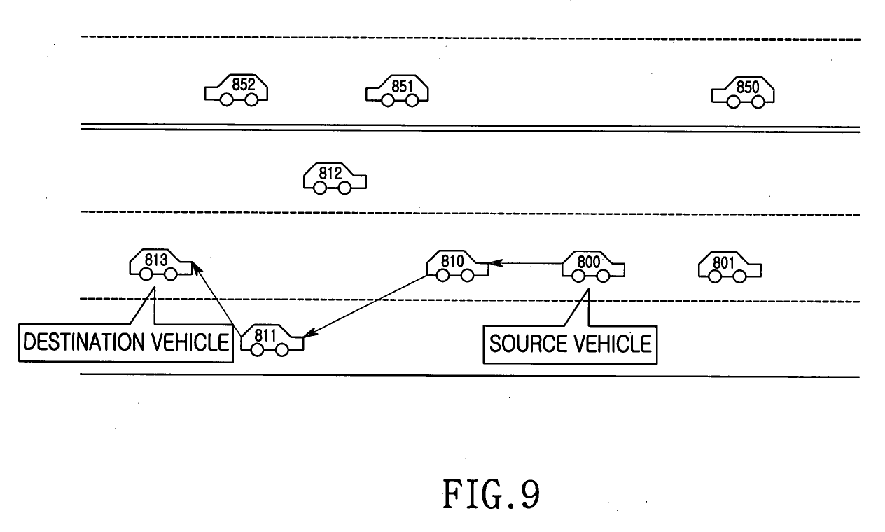

FIGS. 8A, 8B and 9 illustrate a method for allowing a vehicle to transmit its own driving information message to a prescribed vehicle according to a forward routing method in accordance with yet another preferred embodiment of the present invention. FIGS. 8A˜8B are header structures of the vehicle management information message, and FIG. 9 is a routing path through which the vehicle management information message is transmitted.

FIG. 8A is a header of a message transmitted to a nearby vehicle 810 in order to allow a vehicle 800 to transmit a vehicle management information message to a specified vehicle 813. A routing type field 300 is set to the forward routing method, and the vehicle 800 selects a specified routing vehicle from among many nearby vehicles in consideration of a distance between the source vehicle 800 itself and the specified vehicle 813, a traveling direction, and speed information. It is assumed that the nearby vehicle 810 is set to a first routing vehicle in the present invention. A routing direction field 315 may remain null, or may be set to a specified direction. If the routing direction field 315 is set to the specified direction, the nearby vehicle 810 selects one vehicle from among nearby vehicles traveling to the specified direction as a routing vehicle for determining the next routing vehicle. Because a routing speed field 320 remains null and does not broadcast a message, a routing area(X) field 325 and a routing area(Y) field 330 remain null.

A destination ID field 335 is set to the specific destination vehicle 813. A destination position field 340 indicates a coordinate of the destination vehicle 813. A destination speed field 345 is set to a speed of the destination vehicle 813 in the case of transmitting the vehicle management information message, and a destination direction field 350 is set to a direction of the destination vehicle 813 in the case of transmitting the vehicle management information message. On the other hand, an available time field 355 is set to a predetermined time of 60 seconds. The message is discarded by a vehicle receiving the message after the lapse of 60 seconds from a predetermined time of 15:20:30 o'clock prescribed in a source time field 380.

The source ID field 360 indicates the vehicle 800 is serving as a source vehicle. A source position field 365, a source speed field 370, and a source direction field 375 indicate that the source vehicle 800 is located at a predetermined coordinate (X800, Y800) and travels to the east at a predetermined speed 70 km/h, when the source vehicle 800 broadcasts a vehicle management information message. A sequence number field 385 indicates that the vehicle management information message transmitted from the vehicle 800 has a predetermined sequence number “126”. A body size field 390 indicates that vehicle management information of 10 bytes is received after the lapse of a predetermined time covered by the header.

FIG. 8B is a header of a message transmitted from the routing vehicle 810 to another nearby vehicle 811 in order to transmit a vehicle management information message created from the source vehicle 800 to the specific destination vehicle 813. The routing vehicle 810 receiving the vehicle management information message from the source vehicle 800 compares its own vehicle driving information collected by the sensor unit 20 with a vehicle traveling requirement prescribed in a header of the message. It is recognized that the routing vehicle 810 is compatible with the routing condition. It is confirmed that the destination vehicle 813 does not exist in the vicinity of the routing vehicle 810, and thus the routing vehicle 810 recognizes the necessity of a routing operation. The routing vehicle 810 sets a vehicle 811 from among nearby vehicles traveling to the east to a routing vehicle in consideration of position, speed, and direction information of the destination vehicle 813. The routing vehicle 810 changes a router ID field 305 of the received message to a router ID field 811, and then transmits the message.

As shown in FIG. 9, the vehicle management information message transmitted from the destination vehicle 800 is received at the communicator 40 of the nearby vehicle 810 determined as a router according to a routing condition prescribed in a message header. The communicator 40 of the routing vehicle 810 recognizes that the routing vehicle 810 functions as a routing vehicle based on a routing condition prescribed in a header of a received message. A message header is changed to another header as shown in FIG. 8B, and the changed header is transmitted to a nearby vehicle 811. It is recognized that the nearby vehicle 811 is set to a router vehicle upon receiving header information of the received message, and it is determined whether the destination vehicle 813 exists in the vicinity of the nearby vehicle 811. If the destination vehicle 813 exists in the vicinity of the routing vehicle 811, the routing vehicle 811 routes the message to the destination vehicle 813. The communicator 40 of the destination vehicle 813 recognizes that the vehicle 813 is set to a destination vehicle upon receiving header information of the message, and then transmits the message to the controller 10.

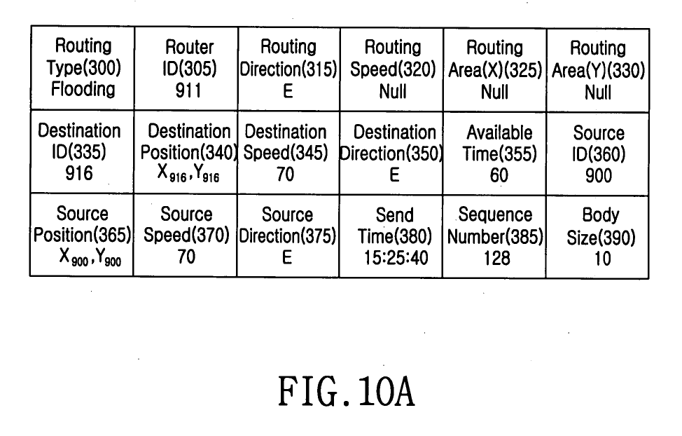

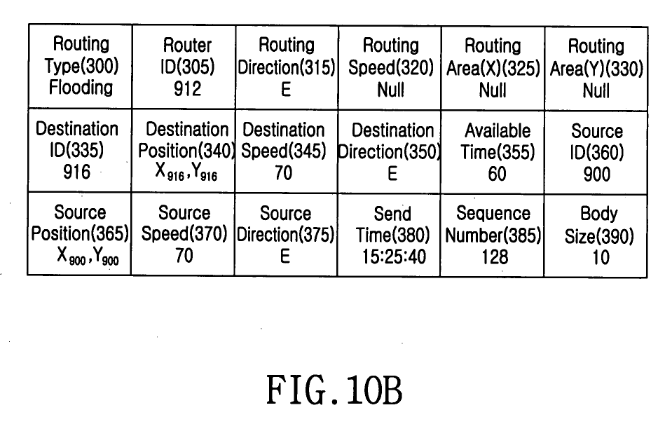

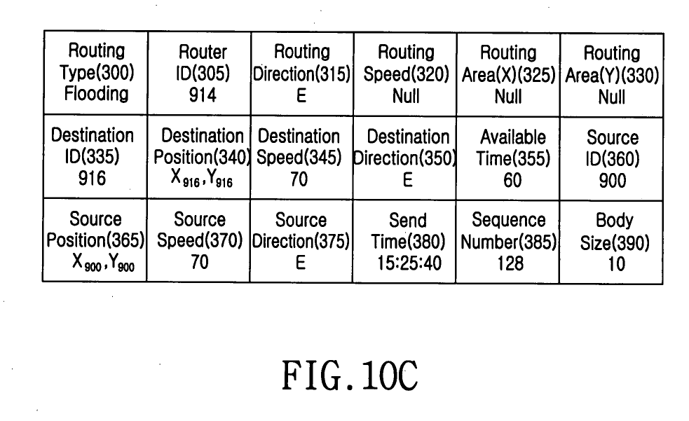

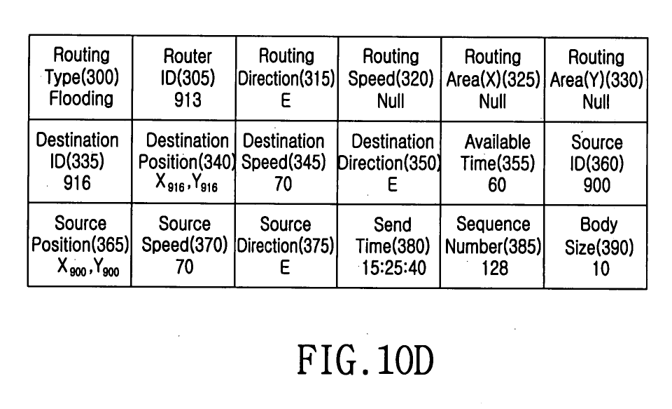

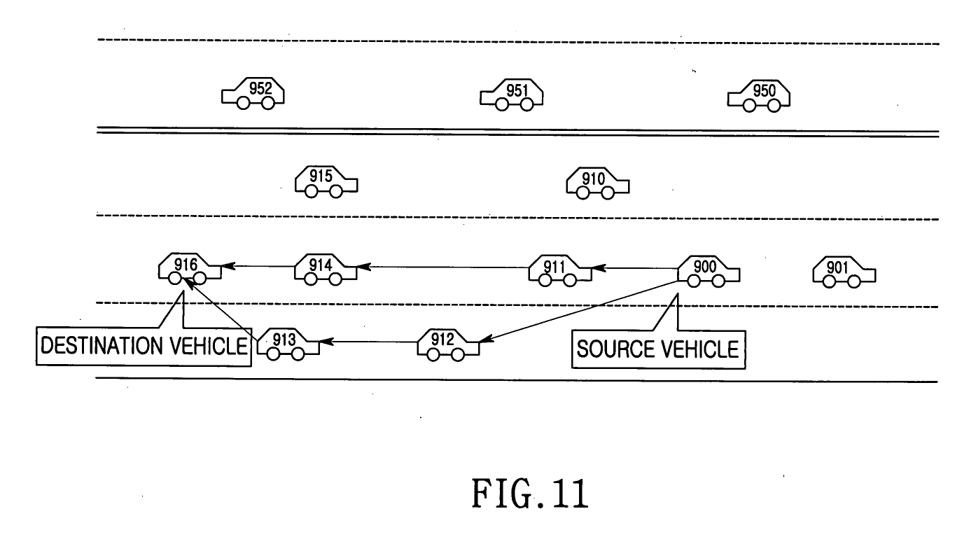

FIGS. 10A, 10B, 10C, 10D, and 11 are conceptual diagrams illustrating a vehicle selecting two routing paths and transmitting the vehicle management information message to a specified vehicle using a flooding routing method. The flooding routing method is adapted to enhance a transfer rate of the message. FIGS. 10A˜10D are header structures of the vehicle management information message, respectively. FIG. 11 is a routing path through which the vehicle management information message is transmitted. A message flooding method will hereinafter be described with reference to FIGS. 10A through 11.

FIG. 11 is a view illustrating a routing path when a source vehicle 900 transmits a driving information message to a specified vehicle 916 according to a flooding routing method. The controller 10 of the source vehicle 900 selects a specified routing vehicle from among nearby vehicles in consideration of a distance between the source vehicle 900 and the specified vehicle 916, and 900's traveling direction and speed information associated with the specified vehicle 916. It is assumed that the nearby vehicles 911 and 912 are set to routing vehicles, respectively. A header of a vehicle management information message transmitted from the source vehicle 900 to the routing vehicle 911 is defined as shown in FIG. 10A. A header of a driving information message transmitted from the source vehicle 900 to the routing vehicle 912 is defined as shown in FIG. 10B. The router type field 300 is set to a flooding routing method. The router ID field 305 is set to the vehicle 911 or the vehicle 912. The remaining fields other than the router ID field 305 in the header shown in FIG. 10A are the same as those in the header shown in FIG. 10B. Definitions of individual fields shown in FIGS. 10A˜10B are similar to those in FIGS. 8A˜8B, such that their detailed description will herein be omitted.

Individual communicators 400 of the nearby vehicles 911 and 912 selected as routers receive a vehicle management information message from the source vehicle 900. It is recognized that vehicles 911 and 912 are set as routing vehicles upon receiving a routing condition prescribed in the header of the message. Individual controllers 10 of the routing vehicles 911 and 912 determine that a destination vehicle 916 prescribed in the vehicle management information message reception condition does not exist in the vicinity of the routing vehicles 911 and 912, and thus recognize the necessity of a routing operation. The routing vehicles 911 and 912 respectively set a vehicle 914 and a vehicle 913 from among nearby vehicles traveling to the east to routing vehicles in consideration of position, speed, and direction information of the destination vehicle 916 and a routing condition prescribed in the message header. As shown in FIGS. 10C˜10D, the routing vehicles 911 and 912 set the router ID field 305 contained in a routing condition of the received vehicle management information message header to the vehicle 914 and the vehicle 913, respectively, and then route the message.

The vehicles 914 and 913 receive the vehicle management information message, recognize that they are set to routing vehicles upon receiving the received vehicle management information message header, and determine whether a destination field 916 prescribed in the message header exists in the vicinity of themselves 914 and 913. Because the destination vehicle 916 exists in the vicinity of the vehicles 914 and 913, the routing vehicles 914 and 913 route the vehicle management information message to the destination vehicle 916. The destination vehicle 916 receives the vehicle management information message from the routing vehicles 914 and 913. The communicator 40 of the destination vehicle 916 determines that the destination vehicle 916 is set to a destination vehicle of the message upon receiving a header of the message, and transmits vehicle management information contained in the message to the controller 10. The destination vehicle 916 recognizes that a routing type field 300 of the vehicle management information message header is set to a flooding routing method. If the destination vehicle 916 repeatedly receives a vehicle management information message wherein the source ID field 360 is set to a vehicle 900 and the sequence number field 385 is set to a predetermined number “128”, the destination vehicle 916 discards the repeatedly received message.

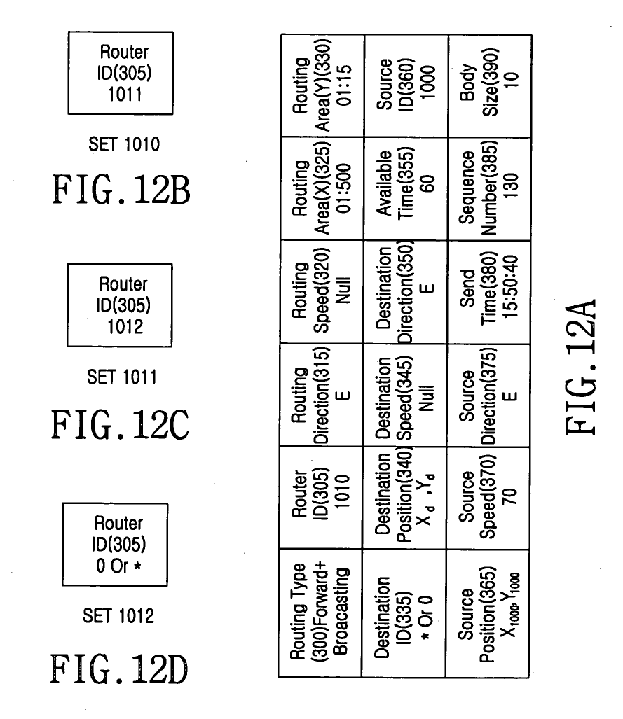

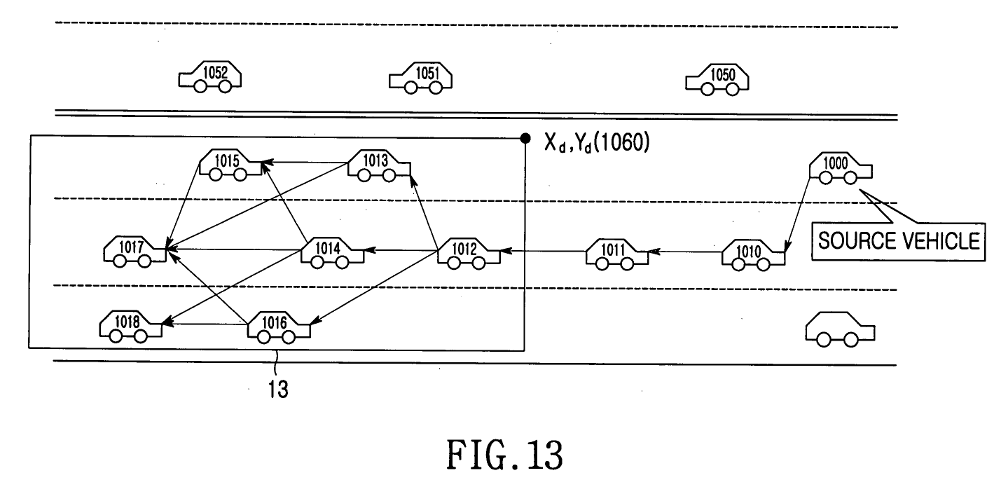

FIGS. 12A, 12B, 12C, 12D, and 13 are conceptual diagrams illustrating a method for allowing a source vehicle to broadcast a vehicle management information message to all vehicles contained in a predetermined area surrounding the source vehicle in accordance with yet another preferred embodiment of the present invention. The message transmission method shown in FIGS. 12˜13 may be performed by a combination between the forward routing method and the broadcasting routing method. This message transmission method provided by such a combination between the forward routing method and the broadcasting routing method will hereinafter be described with reference to FIGS. 12˜13.

FIG. 13 is a view illustrating a routing path of the vehicle management information message when a source vehicle 1000 broadcasts its own vehicle management information message to all the vehicles contained in a prescribed area 13 covering a left distance 15 m and a rear distance 500 m based on a reference point located at a rear distance 200 m. The source vehicle 1000 sets a nearby vehicle 1010 to a routing vehicle in consideration of its own distance, traveling direction, and speed information associated with the reference point.

The source vehicle 1000 sets up a message header transmitted to the routing vehicle 1010 as shown in FIG. 12A. A routing type field 300 is set to a “Broadcasting after Forward routing” method. The router ID field 305 is set to a vehicle 1010. A routing direction field 315 from among vehicle driving requirements for the routing condition is set to the east, such that only vehicles traveling to the east can route the message. A routing speed field 320 remains null, vehicle speed information is not contained in the routing condition. A routing area(X) field 325 is set to a predetermined value “01:500”, and indicates that the message is broadcast in a prescribed area covering a predetermined distance 500 m in a rear direction of a reference position prescribed in the destination position field 340. A routing area(Y) field 330 is set to a predetermined value “01:15”. The message is routed in a predetermined area covering a prescribed distance of 15 m in a leftward direction of a coordinate prescribed in the destination position field 340. In more detail, a vehicle management information message broadcast from the source vehicle 1000 according to the header information is broadcast to vehicles traveling to the east in a prescribed broadcasting area covering a distance 15 m to the left and a distance 500 m to the rear based on a reference position prescribed in the destination position field 340.

The destination ID field 335 is set to a predetermined character “0” or “*”, and indicates that a specific destination vehicle is not determined. A destination position field 340 is set to a predetermined coordinate (Xd, Yd) 1060, and indicates a reference position at which the message is broadcast. In this case, the destination speed field 350 is set to the east whereas the destination speed field 345 remains null, such that a vehicle traveling to the east within the broadcasting area irrespective of vehicle speed information can receive a message broadcast from the source vehicle 600. On the other hand, an available time field 355 is set to a predetermined time of 60 seconds. The message is discarded by a vehicle receiving the message after the lapse of 60 seconds from a predetermined time of 15:20:30 o'clock prescribed in a source time field 380. Fields other than the discarded message field are similar to those of the aforementioned preferred embodiments, such that their detailed description will herein be omitted.

A routing vehicle 1010 receiving a vehicle management information message having a header shown in FIG. 12A determines that a routing type is set to the broadcasting routing method after the header transmits the routing type information. Then, the vehicle 1010 recognizes that the vehicle 1010 is set to a routing vehicle by referring to the router ID field 305 of the header. A communicator 40 of the routing vehicle 1010 compares its own vehicle driving information with a predetermined vehicle driving requirement defined in a routing condition contained in its own header. It is recognized that the vehicle 1010 exists outside of a predetermined broadcasting area defined in the header, such that the vehicle 1010 determines that the vehicle management information message needs to be routed. The routing vehicle 1010 compares its own vehicle driving information with vehicle management information of nearby vehicles, and sets a nearby vehicle 1011 to the next routing vehicle according to a routing condition defined in the header. As shown in FIG. 12B, information “1010” recorded in a router ID field 305 contained in the header of a received message is switched to another information “1011”, such that the routing vehicle 1010 corresponding to the information “1010” is also switched to another routing vehicle 1011 corresponding to the information “1011” which is contained in a nearby vehicle, and thus the routing vehicle 1010 routes the message to the vehicle 1011.

The nearby vehicle 1011 functioning as a router changes information of a router ID field 305 contained in the header of the vehicle management information message to new information 1012 as shown in FIG. 12C, such that the routing vehicle 1011 is also changed to the vehicle 1012 and thus the message is routed to the vehicle 1012. The nearby vehicle 1012 receiving the message recognizes that the vehicle 1012 exists in the broadcasting area by referring to header information of the message, converts information of the router ID field 305 into a new value “0” or “*” as shown in FIG. 12D, and then broadcasts the message to the nearby vehicles 1013, 1014, and 1016. The nearby vehicle 1012 transmits a message received through the communicator 40 to the controller 10. The vehicles 1013, 1014, and 1016 broadcast the message to the nearby vehicles 1015, 1017, and 1018. Individual communicators 40 of the vehicles 1012 to 1018 contained in the broadcasting area transmit vehicle management information contained in the vehicle management information message to individual controllers 10, respectively. In this case, a vehicle 1052 or 1051 traveling to the west may receive the broadcasting message, but it is recognized that the vehicle 1052 or 1051 does not exist in the broadcasting area upon receiving the message header, such that the received message is discarded.

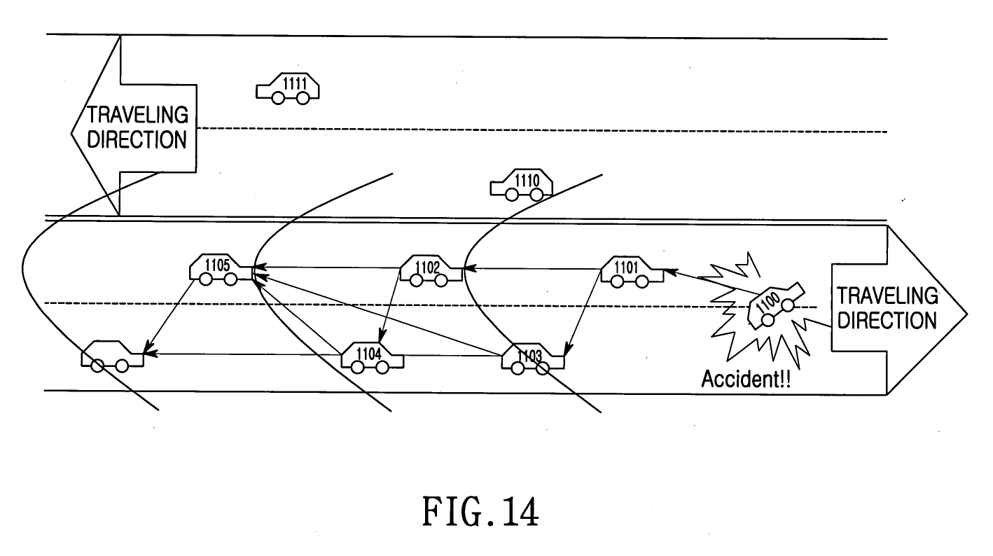

FIG. 14 is a conceptual diagram of a method for broadcasting a traffic accident warning message in accordance with a preferred embodiment of the present invention. Referring to FIG. 14, an accident vehicle 1100 transmits a message warning nearby vehicles traveling to a location of a traffic accident, resulting in prevention of further traffic accidents and collisions. The traffic accident vehicle 1100 can broadcast a message indicating a traffic accident occurrence to vehicles contained in a prescribed area using the method shown in FIG. 7. The broadcasting area is set up considering, for example, road environment information and overall vehicle driving environment information. In this case, the road environment information includes, for example, a road width or degree of curvature of a road, and the overall vehicle driving environment information includes, for example, a current traveling speed and a weather condition. Vehicles receiving the traffic accident warning message from a source vehicle inform their drivers of this traffic accident warning message using their message displays 35 and their voice processors 31.

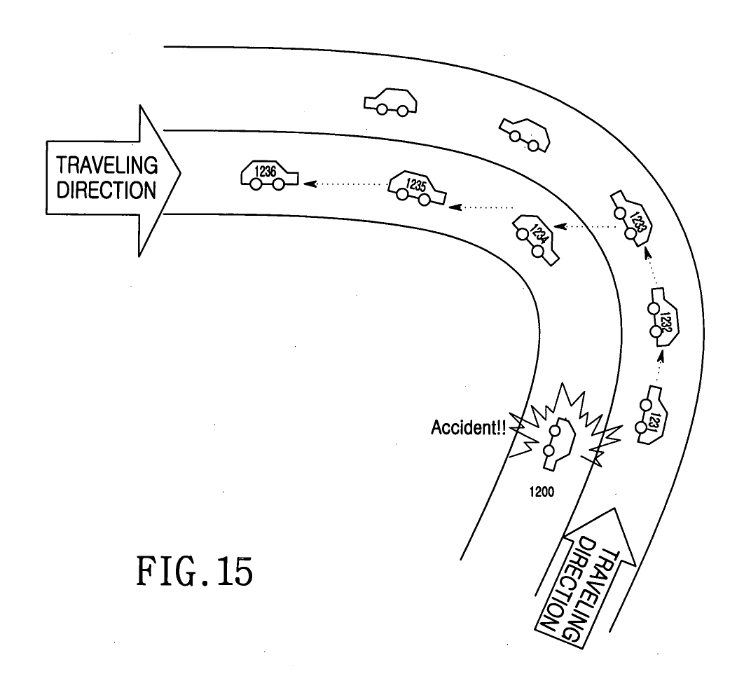

FIG. 15 is a conceptual diagram of a method for broadcasting a traffic accident warning message in accordance with another preferred embodiment of the present invention. Compared with FIG. 14, FIG. 15 illustrates a method for broadcasting a traffic accident warning message if there is no nearby vehicle traveling toward the traffic accident vehicle. It is assumed that a “Broadcasting after Forward routing” method is applied to the present invention. If there is no nearby vehicle traveling toward the traffic accident vehicle 1200, the traffic accident vehicle 1200 sets a vehicle 1231 from among nearby vehicles to a routing vehicle, sets up routing vehicle and broadcasting area information in a message header, and broadcasts the setup information to the routing vehicle. The message received at the routing vehicle 1231 is transmitted to a vehicle 1234 traveling in the broadcasting area via vehicles 1232 and 1233. The vehicle 1234 broadcasts the message to the nearby vehicles according to a routing condition prescribed in the message header.

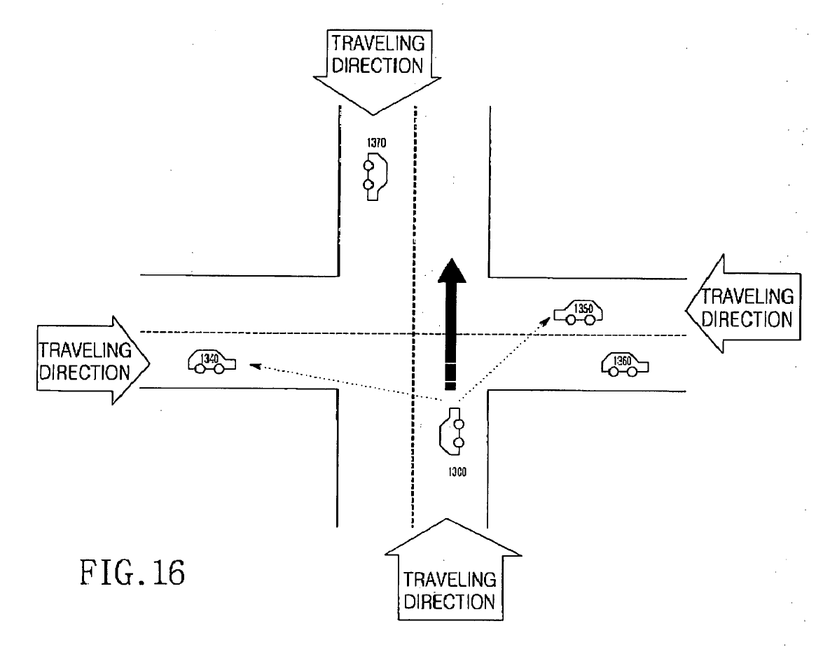

FIG. 16 is a conceptual diagram of a method for broadcasting a message adapted to warn nearby vehicles of the source vehicle's entrance into a crossroads in accordance with yet another preferred embodiment of the present invention. It is assumed that the broadcasting routing method shown in FIG. 7 is applied to the present invention. A vehicle 1300 about to enter a crossroads receives information associated with the crossroads from an electronic map 29. The vehicle 1300 determines whether there is a predetermined broadcasting area in the vicinity of the crossroads and broadcasts its own vehicle management information to nearby vehicles in the vicinity of the crossroads considering traveling directions and speeds of the nearby vehicles. In this case, the broadcasting area is determined based on the width of the crossroads, and speed and traveling directions of the vehicles. The vehicle management information includes position, speed and direction information of the vehicles. Vehicles 1340 and 1350 receiving a crossroads warning message from the vehicle 1300 transmits the received crossroads warning message to the controller 10, and informs their drivers of the crossroads warning message using the display 35 and the voice processor 31.

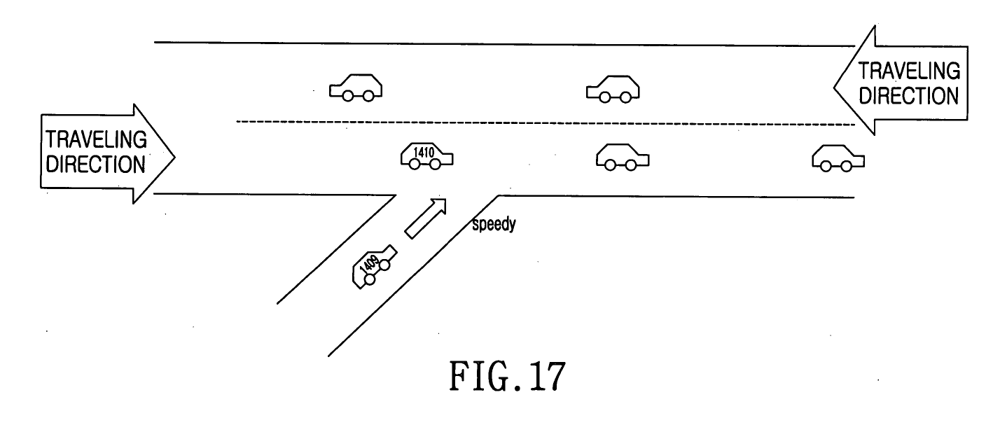

FIG. 17 is a conceptual diagram of a method for broadcasting a warning message to inform vehicles located on a main road of the entrance of the source vehicle to the main road from an arterial road in accordance with yet another preferred embodiment of the present invention. It is assumed that the forward routing method shown in FIG. 9 is applied to the present invention. A vehicle 1400 entering from an arterial road to a main road checks necessary road information from the electronic map 29, and recognizes that the arterial road is connected to the main road. The vehicle 1400 determines whether there is a vehicle traveling the main road upon receiving vehicle management information messages from nearby vehicles, and determines a possibility of traffic accident or collision between vehicles based on the received vehicle management information messages. If there is the possibility of a traffic accident or collision between the vehicle 1400 on an arterial road and a vehicle 1410 on the main road, the vehicle 1400 transmits a warning message indicating its own entrance to the main road to the vehicle 1410. The vehicle 1410, receiving the warning message, transmits the message to the controller 10 and transmits the warning message to its own driver using the message display 35 and the voice processor 31.

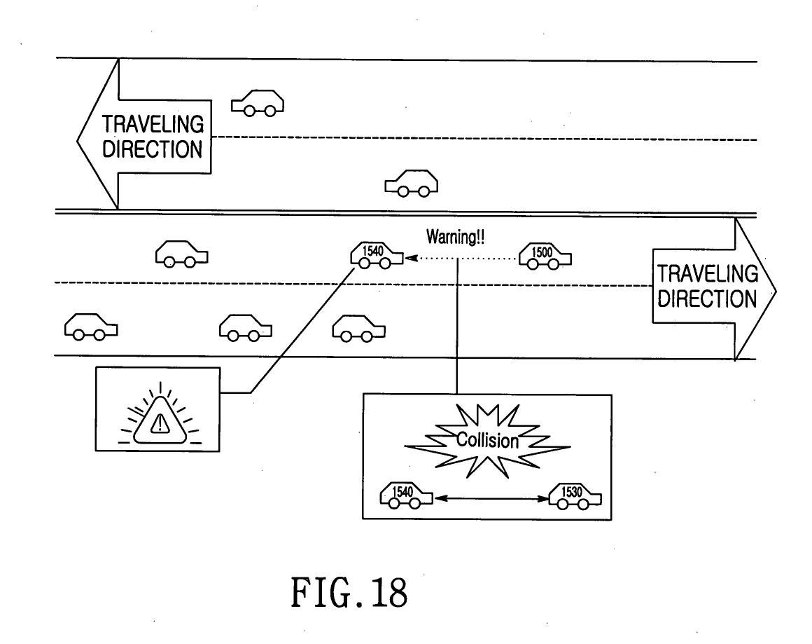

FIG. 18 is a conceptual diagram of a method for transmitting a message to warn of an impending traffic accident or collision to a certain vehicle in accordance with yet another preferred embodiment of the present invention. It is assumed that the forward routing method shown in FIG. 9 is applied to the present embodiment. A vehicle 1500 forms an ad-hoc network between the vehicle 1500 and nearby vehicles, periodically communicates vehicle management information between the vehicles, or frequently communicates such vehicle management information between the vehicles. The vehicle 1500 compares its own vehicle management information with vehicle management information of nearby vehicles using the controller 10, and determines whether there is a certain vehicle capable of colliding with the vehicle 1500. If a vehicle 1540 capable of colliding with the vehicle 1500 is found, the vehicle 1500 transmits a collision warning message to the vehicle 1540 using the forward routing method shown in FIG. 9.

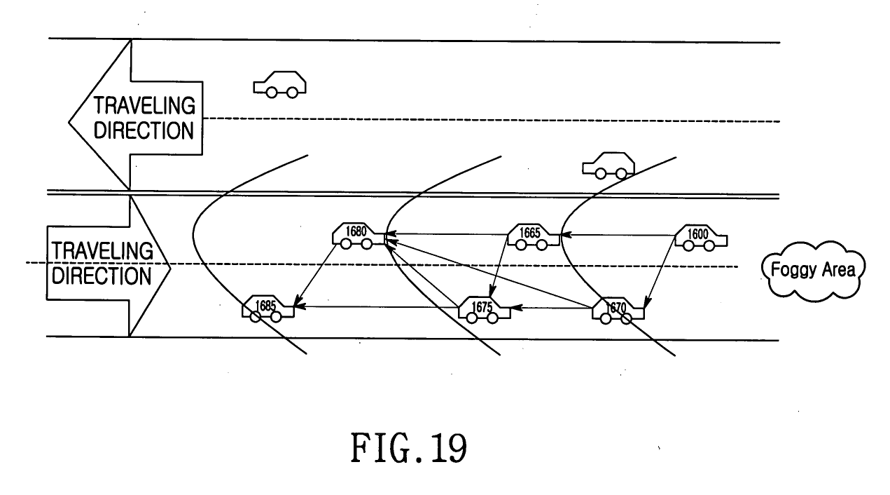

FIG. 19 is a conceptual diagram of a method for broadcasting a weather condition message to nearby vehicles in accordance with yet another preferred embodiment of the present invention. A vehicle 1600 detects various weather condition information, for example, fog, rain, snow, and abrupt temperature change information, etc., using the weather sensor 27. The vehicle 1600 broadcasts information collected by the weather sensor 27 and a deceleration warning message, etc. to nearby vehicles according to the broadcasting routing method shown in FIG. 5. The vehicle 1600 may broadcast the message to nearby vehicles according to the Broadcasting after Forward routing method shown in FIG. 13.

As apparent from the above description, the present invention forms an ad-hoc network between vehicles, communicates vehicle management information between the vehicles, and thus provides their drivers with overall traffic condition information. In addition, the present communicates vehicle management information between vehicles, and thus effectively prevents the vehicles from colliding with each other. Furthermore, the present invention sets up a routing path in real time based on vehicle management information, and thus creates an optimum routing path even though the vehicles travel at a high speed.

Although the preferred embodiments of the present invention have been disclosed for illustrative purposes, those skilled in the art will appreciate that various modifications, additions and substitutions are possible without departing from the scope and spirit of the invention as disclosed in the accompanying claims.

What is claimed is:

1. A method for forming an ad-hoc network between vehicles to communicate vehicle management information between them, comprising the steps of:
collecting, by a source vehicle, its own vehicle driving information, and creating vehicle management information of the source vehicle based on the vehicle driving information;
setting up, by source vehicle, a routing condition composed of predetermined vehicle traveling requirements based on the vehicle management information, and transmitting a vehicle management information message having the routing condition and the vehicle management information to nearby vehicles;
searching, by the nearby vehicles, for the routing condition upon receiving the vehicle management information message; and
determining whether the nearby vehicles route the vehicle management information message according to the routing condition.

2. The method as set forth in claim 1, wherein the routing condition is contained in a header of the vehicle management information message, and the vehicle management information of the source vehicle is contained in a main body of the vehicle management information message.

3. The method as set forth in claim 2,
wherein the step for searching the routing condition includes the steps of:
searching, by the nearby vehicles, for the routing condition upon receiving header information of the vehicle management information message; and
comparing, with the nearby vehicles, their vehicle driving information with the vehicle traveling requirements contained in the routing condition.

4. The method as set forth in claim 3,
wherein, in the collecting step, the step of creating vehicle management information includes the steps of
creating, with the source vehicle, vehicle safety information based on its own vehicle driving information and the vehicle driving information of the nearby vehicles, and including at least one of position and direction of the source vehicle in the vehicle driving information; and
creating the vehicle management information using at least one of the vehicle driving information and the vehicle safety information of the source vehicle.

5. The method as set forth in claim 4,
wherein the vehicle safety information includes
a first warning message indicating an imminent traffic collision between vehicles,
a second warning message indicating a traffic accident occurrence, and
a third warning message indicating the entrance of the source vehicle to a crossroads.

6. The method as set forth in claim 3,
wherein the source vehicle sets up a message reception condition to allow only vehicles satisfying a prescribed vehicle traveling requirement from among the predetermined vehicle traveling requirements to receive the vehicle management information message, includes the message reception condition in the routing condition, and then transmits the message.

7. The method as set forth in claim 6,
wherein the vehicle traveling requirement includes at least one of vehicle position, speed, and direction information.

8. The method as set forth in claim 6,
wherein the vehicle management information message is transmitted to a driver if the nearby vehicles are compatible with the message reception condition.

9. The method as set forth in claim 7,
wherein the routing condition further includes ID (Identification) and routing area information of a routing vehicle, and the message reception condition further includes ID information of a destination vehicle.

10. The method as set forth in claim 9,
wherein the source vehicle sets each of the routing vehicle ID and the destination vehicle ID to a null value, and broadcasts the vehicle management information message to the nearby vehicles.

11. The method as set forth in claim 10,
wherein the source vehicle sets the routing area to a predetermined area, sets vehicle position information contained in the vehicle traveling requirement of the message reception condition to a reference position of the routing area, and broadcasts the vehicle management information message to nearby vehicles contained in the predetermined area.

12. The method as set forth in claim 9,
wherein the source vehicle sets the destination vehicle ID to a specified vehicle, sets the routing vehicle ID to an ID of the specified vehicle based on the vehicle driving information of the specified vehicle, and transmits the vehicle management information message to the specified vehicle.

13. The method as set forth in claim 12,
wherein the source vehicle sets up a plurality of routing vehicle IDs, and transmits the vehicle management information message to the specified vehicle using a flooding method.

14. An apparatus for forming an ad-hoc network between a source vehicle and nearby vehicles to communicate vehicle management information between them, the apparatus comprising:
a sensor for collecting vehicle driving information including at least one of vehicle position, direction, and speed information of the source vehicle;
a communicator for receiving a vehicle management information message having vehicle management information and a routing condition of nearby vehicles from the nearby vehicles, for inserting a predetermined vehicle traveling requirement into the routing condition, for comparing the vehicle traveling requirement with the collected vehicle driving information, and for determining whether the vehicle management information message is routed; and
a display for informing a driver of the collected vehicle driving information.

15. The apparatus as set forth in claim 14,
wherein the routing condition is contained in a header of the vehicle management information message, and the vehicle management information is contained in a main body of the vehicle management information message.

16. The apparatus as set forth in claim 14,
wherein the vehicle traveling requirement includes at least one of vehicle position, speed, and direction information.

17. The apparatus as set forth in claim 14,
wherein the vehicle management information message includes a message reception condition composed of a plurality of predetermined vehicle traveling requirements.

18. The apparatus as set forth in claim 17, further comprising:
a controller for receiving the vehicle management information message from the communicator if the communicator determines that the vehicle driving information is compatible with the vehicle traveling requirements defined in the message reception condition.

19. An apparatus for forming an ad-hoc network between a source vehicle and nearby vehicles to communicate vehicle management information between them, the apparatus comprising:
a sensor for collecting vehicle driving information including at least one of vehicle position, direction, and speed information of the source vehicle;
a communicator for receiving vehicle driving information of nearby vehicles;
a controller for creating vehicle management information based on individual vehicle driving information of the source vehicle and the nearby vehicles, for setting up a predetermined routing condition for routing the vehicle management information, for inserting a predetermined vehicle traveling requirement into the routing condition, and for creating a vehicle management information message having the routing condition and the vehicle management information; and
a display for informing a driver of the vehicle driving information of the source vehicle and the vehicle management information.

20. The apparatus as set forth in claim 19,
wherein the routing condition is contained in a header of the vehicle management information message, and the vehicle management information of the source vehicle is contained in a main body of the vehicle management information message.

21. The apparatus as set forth in claim 19,
wherein the controller creates vehicle safety information upon receiving the vehicle driving information of the source vehicle and the nearby vehicles, and creates the vehicle management information using at least one of the vehicle driving information and the vehicle safety information of the source vehicle.

22. The apparatus as set forth in claim 21,
wherein the vehicle safety information includes
a first warning message indicating an imminent traffic collision between vehicles,
a second warning message indicating a traffic accident occurrence, and
a third warning message indicating the entrance of the source vehicle to a crossroads.

23. The apparatus as set forth in claim 20,
wherein the source vehicle sets up a message reception condition to allow only vehicles satisfying the predetermined vehicle traveling requirement to receive the vehicle management information message, includes the message reception condition in the routing condition, and then transmits the message.

24. The apparatus as set forth in claim 23,
wherein the vehicle traveling requirement includes at least one of vehicle position, speed, and direction information.

25. The apparatus as set forth in claim 24,
wherein the routing condition further includes ID (Identification) and routing area information of a routing vehicle, and the message reception condition further includes ID information of a destination vehicle.

26. The apparatus as set forth in claim 25,
wherein the source vehicle sets each of the routing vehicle ID and the destination vehicle ID to a null value, and broadcasts the vehicle management information message to the nearby vehicles.

27. The apparatus as set forth in claim 26,
wherein the source vehicle sets the routing area to a predetermined area, sets vehicle position information contained in the vehicle traveling requirement of the message reception condition to a reference point of the routing area, and broadcasts the vehicle management information message to nearby vehicles contained in the predetermined area.

28. The apparatus as set forth in claim 25,
wherein the source vehicle sets the destination vehicle ID to a specified vehicle, sets the routing vehicle ID to an ID of the specified vehicle to based on the vehicle driving information of the specified vehicle, and transmits the vehicle management information message to the specified vehicle.

29. The apparatus as set forth in claim 25,
wherein the source vehicle sets the destination vehicle ID to a specified vehicle, sets up a plurality of routing vehicle IDs, and transmits the vehicle management information message to the specified vehicle using a flooding method.

30. A method for forming an ad-hoc network between a source vehicle and nearby vehicles to communicate vehicle management information between them comprising the steps of:
collecting vehicle driving information including at least one of vehicle position, direction, and speed information of the source vehicle;
receiving vehicle management information message having vehicle management information and a routing condition of nearby vehicles from the nearby vehicles, inserting a predetermined vehicle traveling requirement into the routing condition, comparing the vehicle traveling requirement with the collected vehicle driving information, and determining whether the vehicle management information message is routed; and
informing a driver of the vehicle driving information of the source vehicle.

31. The method as set forth in claim 30,
wherein the routing condition is contained in a header of the vehicle management information message, and the vehicle management information is contained in a main body of the vehicle management information message.

32. The method as set forth in claim 30,
wherein the vehicle traveling requirement includes at least one of vehicle position, speed, and direction information.

33. The method as set forth in claim 30,
wherein the vehicle management information message includes a message reception condition having the predetermined vehicle traveling requirement.

34. The method as set forth in claim 33,
wherein the vehicle management information message is transmitted to a driver if the source vehicle determines that the vehicle driving information is compatible with the vehicle traveling requirement defined in the message reception condition.

35. A method for forming an ad-hoc network between a source vehicle and nearby vehicles to communicate vehicle management information between them comprising the steps of:
collecting vehicle driving information including at least one of vehicle position, direction, and speed information of the source vehicle, receiving vehicle driving information of nearby vehicles from the nearby vehicles;
creating vehicle management information based on the vehicle driving information of the source vehicle and the nearby vehicles, setting up a routing condition for routing the vehicle management information, inserting a predetermined vehicle traveling requirement into the routing condition, and creating a vehicle management information message having the routing condition and the vehicle management information; and
informing a driver of the vehicle driving information and the vehicle management information of the source vehicle.

36. The method as set forth in claim 35,
wherein the routing condition is contained in a header of the vehicle management information message, and the vehicle management information of the source vehicle is contained in a main body of the vehicle management information message.

37. The method as set forth in claim 35,
wherein the source vehicle creates vehicle safety information based on its own vehicle driving information and vehicle driving information of the nearby vehicles, and the vehicle management information is created using at least one of the vehicle driving information and the vehicle safety information of the source vehicle.

38. The method as set forth in claim 37,
wherein the vehicle safety information includes
a first warning message indicating an imminent traffic collision between vehicles,
a second warning message indicating a traffic accident occurrence, and
a third warning message indicating the entrance of the source vehicle to a crossroads.

39. The method as set forth in claim 36,
wherein the source vehicle sets up a message reception condition to allow only vehicles satisfying the predetermined vehicle traveling requirement to receive the vehicle management information message, includes the message reception condition in the routing condition, and then transmits the message.

40. The method as set forth in claim 39,
wherein the vehicle traveling requirement includes at least one of vehicle position, speed, and direction information.

41. The method as set forth in claim 40,
wherein the routing condition further includes ID (Identification) and routing area information of a routing vehicle, and the message reception condition further includes ID information of a destination vehicle.

42. The method as set forth in claim 41,
wherein the source vehicle sets each of the routing vehicle ID and the destination vehicle ID to a null value, and broadcasts the vehicle management information message to the nearby vehicles.

43. The method as set forth in claim 42,
wherein the source vehicle sets the routing area to a predetermined area, sets vehicle position information contained in the vehicle traveling requirement of the message reception condition to a reference point of the routing area, and broadcasts the vehicle management information message to nearby vehicles contained in the predetermined area.

44. The method as set forth in claim 41,
wherein the source vehicle sets the destination vehicle ID to a specified vehicle, sets the routing vehicle ID to an ID of the specified vehicle to based on the vehicle driving information of the specified vehicle, and transmits the vehicle management information message to the specified vehicle.

45. The method as set forth in claim 41,
wherein the source vehicle sets the destination vehicle ID to the specified vehicle, sets up a plurality of routing vehicle IDs, and transmits the vehicle management information message to the specified vehicle using a flooding method.

46. The method as set forth in one of claims 4, 30 and 35,
wherein the vehicle driving information includes information indicating a traffic accident occurrence of the source vehicle.

47. The apparatus as set forth in one of claims 14 and 19,
wherein the vehicle driving information includes information indicating a traffic accident occurrence of the source vehicle.
